(19) United States
(12) Patent Application Publication
(10) Pub. No.: US 2025/0237316 A1
(43) Pub. Date: Jul. 24, 2025

(54) SEALING RIB FOR A DIAPHRAGM VALVE

(71) Applicant: Georg Fischer Rohrleitungssysteme AG, Schaffhausen (CH)

(72) Inventors: Alexander EBAUER, Schaffhausen (CH); Eva Stoll, Klettgau (DE); Stefan Buergi, Basadingen (CH); Timo Jaeckle, Hilzingen (DE); Dejan Mitrovic, Hüfingen (DE)

(21) Appl. No.: 19/026,878

(22) Filed: Jan. 17, 2025

(30) Foreign Application Priority Data
Jan. 18, 2024 (EP) 24152504.7

(51) Int. Cl. F16K 27/02; F16K 7/12

(52) U.S. Cl. CPC F16K 27/0236; F16K 7/126

(57) ABSTRACT

A diaphragm valve for controlling a flow of a medium in a pipeline, the diaphragm valve comprising a housing upper part, a housing lower part, an actuation unit, a diaphragm and an inner housing which presses against the diaphragm, wherein the diaphragm lies on a bearing region of the housing lower part and is compressed by means of a clamping region of the inner housing, wherein the diaphragm has a sealing rib on the bottom side facing towards the medium, and the inner housing has a rib extending in the clamping region, wherein the rib is arranged vertically above the sealing rib.

### CROSS-REFERENCE TO RELATED APPLICATIONS

This application claims the benefit and priority of European Patent Application No. 24152504.7 filed Jan. 18, 2024. The entire disclosure of the above application is incorporated herein by reference.

### BACKGROUND OF THE INVENTION

### Technical Field

The invention relates to a diaphragm valve for controlling a flow of a medium in a pipeline, the diaphragm valve comprising a housing upper part, a housing lower part, an actuation unit, a diaphragm and an inner housing which presses against the diaphragm, wherein the diaphragm lies on a bearing region of the housing lower part and is compressed by means of a clamping region of the inner housing.

In the customary design of the diaphragm valve on the market, the lower part is connected to the upper part by means of screws and nuts and optionally washers, and the diaphragm is arranged in between. The tightening of the individual screw connections causes the diaphragm to be compressed, thus achieving the minimum contact pressure required for the sealing action.

### Discussion

One further development of the design consists in the provision of a central housing nut screw connection, for example in the case of the diaphragm valve disclosed in EP 2 236 874 A1.

Disadvantages of the known prior art consist in that, in the variant having the central housing nut screw connection, the axial force must be imparted by means of this single screw connection, which requires a high tightening moment in relation to a plurality of individual screws.

This does not constitute a problem, and can be implemented using a tool such as a strap wrench, in the case of small dimensions of the diaphragm valve, but can scarcely be implemented in the case of large embodiments.

It is apparent from the formula F=P*A (force=pressure*area) that the compressed area (or area over which pressure is exerted on the diaphragm) is a linear factor for the axial force. In the case of the customary solutions on the market, the area over which pressure is exerted is large, which means that a high force must be imparted in order to achieve a sufficient pressure on the seal, or a sufficiently high contact pressure, in order that the valve is sealed. An increased load is exerted on the individual components, which can lead to premature failure at the valve.

### SUMMARY

It is an aspect of the invention to propose a diaphragm valve in the case of which the sealing action can be achieved without the need for high axial forces, and the load on the individual components of the valve is thus reduced, and in the case of which the assembly of the valve is also simplified.

Said aspect is achieved in that the diaphragm has a sealing rib on the bottom side facing towards the medium, and the inner housing has a rib extending in the clamping region, wherein the rib is arranged vertically above the sealing rib.

The diaphragm valve according to preferred embodiment of the invention for controlling the flow of a medium in a pipeline comprises a housing upper part and a housing lower part, preferably consisting of plastics material. The housing upper part and lower part are preferably screwed together by means of a thread arranged on the housing upper part and lower part. The diaphragm valve has an actuation unit by means of which the diaphragm valve is actuated. The actuation unit preferably comprises a spindle, a spindle nut and a diaphragm holder which is connected by means of a connecting element to the diaphragm and which acts on the diaphragm, wherein the pressure force is transmitted via a thrust piece. The actuation unit furthermore preferably has a plurality of spindle variants, whereby the connection can be made using a manual, electrical or pneumatic drive action. The diaphragm valve has a diaphragm for controlling the flow, and divides the diaphragm valve into a region through which medium flows and a region which is free from medium. In the housing, the diaphragm is pressed against a bearing region of the housing lower part by an inner housing which presses against the diaphragm, or said diaphragm is clamped between said bearing region and inner housing. The housings are preferably of circular area in the region in which they engage with one another, and are of cylindrical form. The bearing surface is preferably formed as an annular surface arranged in the housing lower part. The diaphragm is compressed against the bearing surface on the housing lower part by a clamping region of the inner housing. The inner housing is preferably of cylindrical form with a circular area, whereby the clamping surface is annular. The diaphragm has a sealing rib on the bottom side facing towards the medium, and the inner housing has a rib extending in the clamping region, wherein the rib is arranged vertically above the sealing rib. The preferably circularly encircling sealing rib is arranged integrally on the diaphragm. The sealing rib preferably forms a sealing lip which projects from the bottom side of the diaphragm and which protrudes over the bottom side. The sealing rib may preferably have a cross-sectional area which tapers to a point or which has a rounded form. The rib arranged on the clamping region of the inner housing preferably extends in circularly encircling form. The rib is raised in relation to the surface of the clamping region or the encircling outer surface, whereby the clamping takes place primarily under the rib. The compression of the diaphragm to achieve the sealing action is thus concentrated in a specific and narrow area, which in turn requires little axial force and, owing to the small area, nevertheless introduces a high pressure into the diaphragm or the sealing rib. It is thus also possible to achieve only a low tightening moment of the housing, and thus easy assembly and maintenance.

It has been found to be advantageous if the rib has a horizontally extending surface or is formed as a plateau.

It has been found to be a preferred embodiment if the rib tapers to a point.

It has been found to be advantageous if the rib and the sealing rib are arranged concentrically with respect to one another. In addition to the sealing rib and the rib being arranged axially in a line one underneath the other or vertically with respect to one another, the sealing rib and the rib are also arranged concentrically with respect to one another in order to ensure that the rib presses vertically against the sealing rib on the diaphragm.

It has been found to be advantageous if the rib has an obliquely extending surface for centring the inner housing relative to the housing lower part. The obliquely extending surface preferably adjoins the outer diameter of the rib. By means of the obliquely extending surface or bevel and the radially adjoining rib, the functions of sealing and centring are decoupled from one another, whereby the both functions can be performed more reliably.

It has proven to be a preferred embodiment if an encirclingly extending bevel is arranged on the bearing surface of the housing lower part. Said bevel serves for centring the diaphragm on the bearing surface on the housing lower part. It is ensured that the pressing force acts almost exclusively on the rib and thus on the sealing rib of the diaphragm in order, as mentioned, to minimize the area over which the axial force acts.

It has proven to be advantageous if the lug has an obliquely extending plane, wherein the oblique plane is arranged parallel to the oblique surface of the rib and serves for centring purposes. The inner housing is thus centred on the housing lower part.

Preferably, a bead is arranged on the diaphragm and serves for centring the diaphragm in the inner housing. The bead is preferably arranged on the upper side facing away from the medium. The bead is centred in the encircling corner that is formed between the oblique surface and the horizontally adjoining outer surface.

The diaphragm is preferably formed from a support diaphragm and a diaphragm plate. The diaphragm plate preferably lies directly against the underside of the support diaphragm. The diaphragm may self-evidently also be formed as a single piece.

It has proven to be advantageous if the diaphragm is of circular form or has a circular basic shape. This allows a uniform distribution of force.

All design options may be freely combined with one another.

### BRIEF DESCRIPTION OF THE DRAWINGS

An exemplary embodiment of the invention will be described on the basis of the figures, wherein the invention is not only restricted to the exemplary embodiment. In the figures:

FIG. 1 shows a partial sectional view through a diaphragm valve,

FIG. 2 shows a detail of an exploded view of the clamping region, and

FIG. 3 shows a partial section of an exploded view of the diaphragm.

### DESCRIPTION OF THE PREFERRED EMBODIMENTS OF THE INVENTION

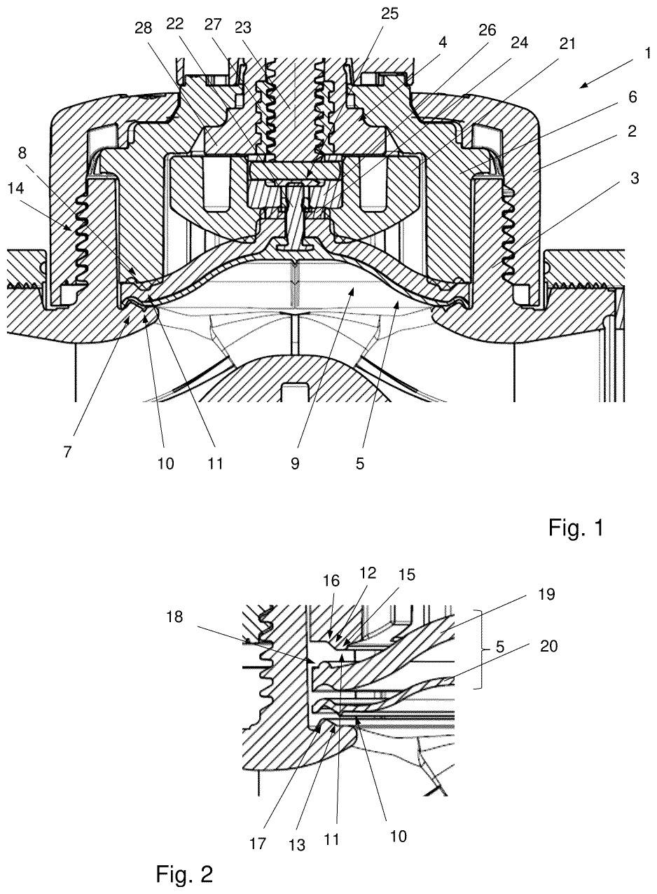

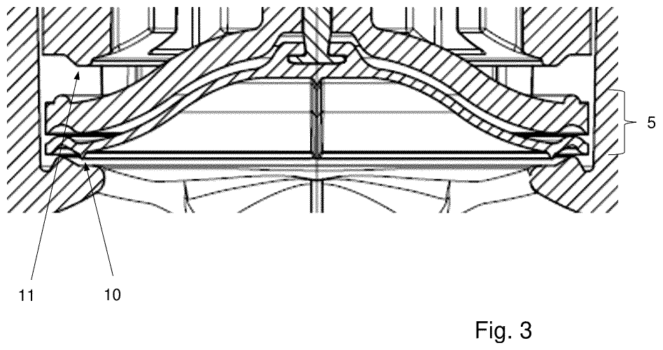

The drawing illustrated in FIG. 1 shows a diaphragm valve 1 according to the invention for controlling a flow of a medium in a pipeline. The diaphragm valve 1 has a housing upper part 2 and a housing lower part 3. Preferably, the housing parts 2, 3 consist of plastics material and have a thread 14 for the purposes of closing one another off. To actuate the diaphragm valve 1, the diaphragm valve 1 has an actuation unit. The actuation unit (4) preferably comprises a thrust piece 21, to which the diaphragm 5 is connected by means of a connecting element 22. It is furthermore advantageous if the actuation unit (4) comprises a spindle (23) and a spindle nut (28) having an overmoulded threaded insert (27). The spindle (23) is preferably connected to the diaphragm holder (26) by means of a grooved pin (25). A hexagonal nut (24) is arranged in the diaphragm holder (26). The threaded pin/the connecting element of the diaphragm (22) is preferably installed in said hexagonal nut (24). In the case of the pneumatically driven diaphragm valve, the spindle preferably moves linearly rather than rotationally, and is directly connected (interlockingly) to the diaphragm holder, and it is then the case that no spindle nut (28) and no grooved pin are required. During the closing movement, the thrust piece (21) pushes the diaphragm against the housing lower part, and during the opening movement, said thrust piece is pulled by way of the connecting element (22). The spindle 23 of the actuation unit (4) is preferably connected to a drive, wherein said drive may be manual, electrical or pneumatic. The diaphragm valve 1 according to the invention has a diaphragm 5 that controls the flow of the medium. The diaphragm 5 furthermore divides the diaphragm valve 1 into a region which is free from medium and a region (9) through which medium flows. The diaphragm valve 1 has an inner housing 6 by means of which the diaphragm 5 is fastened and positioned in the housing. The diaphragm 5 lies on a bearing region 7 of the housing lower part 3 and is compressed by a clamping region 8 of the inner housing 6. In order to be able to implement a high contact pressure with a low axial force, the diaphragm has a sealing rib 10 and the inner housing 6 has a rib 11 in the clamping region. The compression of the diaphragm 5 is thus achieved almost exclusively over the area of the rib 11 and of the sealing rib 10. For this purpose, the rib 11 and the sealing rib 10 are arranged vertically one above the other, as can be clearly seen from FIGS. 1 to 3. It is advantageous if the rib 11 and the sealing rib 10 are concentric. The diaphragm 5 furthermore preferably has a circular basic shape. It can be clearly seen from FIGS. 2 and 3 that the rib 11 has an obliquely extending surface 12 for centring purposes. The inner housing 6 is thus centred on the housing lower part 3, which likewise has an obliquely extending plane 13 extending parallel to the oblique surface 12, whereby optimum positioning is achieved. It is advantageous if said housing lower part has a lug 17 on the bearing region 7. The oblique plane 13 is arranged on said lug and, like the lug 17, also serves for centring the diaphragm 5. It has been found to be advantageous if a bead 18 is arranged on the top side of the diaphragm 5. Said bead serves for centring the diaphragm 5 relative to the inner housing 6. The bead 18 is preferably centred on the encircling corner 16 in the inner housing 6, which is formed between the horizontally extending outer surface 15 and the oblique surface 12. The diaphragm 5 is preferably made up of a support diaphragm 19 and a diaphragm plate 20, wherein the diaphragm plate 20 preferably lies against the support diaphragm 19. Although not apparent from the figures, the diaphragm 5 may self-evidently also be formed as one piece, and need not consist of a support diaphragm 19 and a diaphragm plate 20.

What is claimed is:

1. A diaphragm valve (1) for controlling a flow of a medium in a pipeline, the diaphragm valve comprising a housing upper part (2), a housing lower part (3), an actuation unit (4), a diaphragm (5) and an inner housing (6) which presses against the diaphragm, wherein the diaphragm lies on a bearing region (7) of the housing lower part (3) and is compressed by means of a clamping region (8) of the inner housing, wherein the diaphragm (5) has a sealing rib (10) on the bottom side (9) facing towards the medium, and the inner housing has a rib (11) extending in the clamping region (8), wherein the rib (11) is arranged vertically above the sealing rib (10).

2. A diaphragm valve (1) according to claim 1, wherein the sealing rib (10) and the rib (11) are of annularly encircling form.

3. A diaphragm valve (1) according to claim 1, wherein the rib (11) and the sealing rib (10) are arranged concentrically.

4. A diaphragm valve (1) according to claim 1, wherein the rib (11) has an obliquely extending surface (12) for centring the inner housing (6) relative to the housing lower part (3).

5. A diaphragm valve (1) according to claim 1, wherein an annularly encircling lug (17) is formed on the bearing surface (7) of the housing lower part (3).

6. A diaphragm valve (1) according to claim 5, wherein the lug (17) has an obliquely extending plane (13), wherein the oblique plane (13) is arranged parallel to the oblique surface (12) of the rib (11) and serves for centring purposes.

7. A diaphragm valve (1) according to claim 1, wherein a bead (18) is arranged on the diaphragm (5) and serves for the centring of the diaphragm (5) in the inner housing (6).

8. A diaphragm valve (1) according to claim 1, wherein the diaphragm (5) is produced from any one of the plastics EPDM, FKM or NBR.

9. A diaphragm valve (1) according to claim 1, wherein the diaphragm (5) has a support diaphragm (19) and a diaphragm plate (20).

10. A diaphragm valve (1) according to claim 1, wherein the sealing rib (10) is arranged integrally on the bottom side of the diaphragm (5).

11. A diaphragm valve (1) according to claim 1, wherein the diaphragm (5) is of circular form or has a circular basic shape.

12. A diaphragm valve (1) according to claim 9, wherein the diaphragm plate (20) is produced from any one of the plastics PTFE, PFA or PE.

13. A diaphragm valve (1) according to claim 9, wherein the support diaphragm (19) is produced from either one of the plastics EPDM and FKM.

14. A diaphragm valve (1) according to claim 1, wherein the rib (11) has a horizontally extending surface or is formed as a plateau.
